(19) United States
(12) Patent Application Publication
(10) Pub. No.: US 2010/0042516 A1
(43) Pub. Date: Feb. 18, 2010

(54) Part Number Set Substitution

(75) Inventors: Ivory Wellman Knipfer, Rochester, MN (US); Fraser Allan Syme, Rochester, MN (US); Matthew H. Zemke, Rochester, MN (US)

Correspondence Address: IBM CORP (YA);C/O YEE & ASSOCIATES PC, P.O. BOX 802333, DALLAS, TX, 75380, US

(73) Assignee: INTERNATIONAL BUSINESS MACHINES CORPORATION, Armonk, NY (US)

(21) Appl. No.: 12/191,170

(22) Filed: Aug. 13, 2008

(51) Int. Cl. G06Q 10/00

(52) U.S. Cl. 705/29

(57) ABSTRACT

An improved manufacturing system for controlling the interchangeability of sets of parts during product installation. In response to receiving a request for an order, a parts list is created for the order. The illustrative embodiments determine whether each part in the parts list is present in current inventory stock. If any of a first group of parts in the parts list is not present in current inventory stock, the illustrative embodiments allow for determining that a second group of parts in the current inventory stock is a valid substitution group for replacing the first group of parts, wherein the number of parts in the first group of parts is not equal to the number of parts in the second group of parts. The illustrative embodiments then update the order by replacing the first group of parts in the parts list with the identified second group of parts.

### BACKGROUND OF THE INVENTION

1. Field of the Invention

The present invention relates generally to an improved manufacturing process, and in particular to a manufacturing process that allows for controlling the interchangeability of sets of parts during product release and build. More specifically, the present invention provides a mechanism that uses part substitution groups to enable a group of parts in a product order to be substituted with another group of parts, wherein the sets may have an unequal number of parts.

2. Description of the Related Art

In a manufacturing environment, a requisition for goods or services, described in terms of exchange of those goods or services for agreed compensation in a contractual form, is called an order. Customers place orders for products that must be manufactured once the order has been placed. For timely manufacturing and delivery of the ordered product, a significant amount of planning, preparation, and procurement procedures are involved in the production process. Accounting systems, planning systems, warehouse management systems, logistics systems, and numerous other systems, support the production planning process to ensure that the orders are capable of being fulfilled. These systems may determine whether orders can be fulfilled based on the buyer's account status, suppliers' inventory levels, manufacturer's own warehouse inventory, quantities on hand, assembly schedule availability, and tooling and personnel availability among other factors.

An order manufacturing system determines if the order can be committed to for delivery on the dates as requested. For materials necessary for manufacturing an order, the manufacturing system breaks down the order into requisite materials. The term “material” used in the context of an order in this manner means the various components, supplies, accessories, and consumable items needed for making the ordered product. For example, for an order for a computer, the materials may include a specific motherboard, a processor of a certain specification, a chassis of certain dimensions, a power supply of certain wattage, and number of screws of a certain size to fasten the motherboard to the chassis. For each order, the manufacturing system generates one or more bills of materials (BOM), which is a listing of materials needed to complete the order.

In many production environments, it is common to have interchangeable or “alternate” parts. A part is an individual component or device which exists prior to being assembled into another component or assembly. An assembly is a group of different parts which are physically connected to each other or are associated with each other. When one part in a group of interchangeable parts is required by a production order, any one of the other parts in this group may be used to satisfy the production demand on a one-to-one substitution basis. For example, three versions of 2 GB memory cards may exist in inventory, all three are functionally equivalent, and so any one of the cards are allowed to fulfill demand for any one of the other cards.

An engineering change (EC) is a change in the parts required for manufacturing a product. Thus, an engineering change requires that a part specified in an original bill of materials for a product is to be replaced with a corresponding part for future manufacturing as specified in an alternate bill of materials for the product. Among several reasons for the substitution, this change may be due to better technology of the substitute part, a cheaper substitute part, or a more effective substitute part. The date on which this change becomes effective is the engineering change cutover date. Thus, the engineering change cutover date of a part is the date when the manufacturing facility is going to change or substitute the part to the different part version, make, or type. For example, a customer may place an order for a specialized computer requiring a specific type of processor as a part. The processor is a part that may have an associated engineering change date that may reflect when processor version A is to be replaced with processor version B for all future deliveries. If the order's commit date falls after the engineering change date for the processor, the bill of materials for manufacturing the specialized computer will contain processor version B and not version A.

### BRIEF SUMMARY OF THE INVENTION

The illustrative embodiments provide an improved manufacturing system for controlling the interchangeability of sets of parts during product installation. In response to receiving a request for an order, a parts list is created for the order. The illustrative embodiments determine whether each part in the parts list is present in current inventory stock. If any of a first group of parts in the parts list is not present in current inventory stock, the illustrative embodiments allow for determining that a second group of parts in the current inventory stock is a valid substitution group for replacing the first group of parts, wherein the number of parts in the first group of parts is not equal to the number of parts in the second group of parts. The illustrative embodiments then update the order by replacing the first group of parts in the parts list with the identified second group of parts.

### BRIEF DESCRIPTION OF THE SEVERAL VIEWS OF THE DRAWINGS

FIG. 1 depicts a pictorial representation of a distributed data processing system in which the illustrative embodiments may be implemented;

FIG. 2 is a block diagram of a data processing system in which the illustrative embodiments may be implemented;

FIG. 3 is a block diagram illustrating an exemplary engineering change break;

FIG. 4 illustrates an exemplary bill of materials structure after a simple engineering change break;

FIG. 5 illustrates an exemplary bill of materials structure after a simple subassembly sourcing change;

FIG. 6 is a block diagram illustrating an exemplary manufacturing system in which the illustrative embodiments may be implemented;

FIG. 7 is a flowchart of a high level process for substituting groups of parts having an unequal number of parts in accordance with the illustrative embodiments;

FIG. 8 is an exemplary control table of mappings defined for allowable substitution sets of parts in accordance with the illustrative embodiments;

FIG. 9 is a flowchart of a sub process for a clear-to-build group substitution in accordance with the illustrative embodiments;

FIG. 10 is a flowchart of a sub process for a user-driven group substitution in accordance with the illustrative embodiments;

FIG. 11 is a flowchart of a process for determining a valid group request in accordance with the illustrative embodiments; and

FIG. 12 is a flowchart of a process for updating an order based on a group substitution in accordance with the illustrative embodiments.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

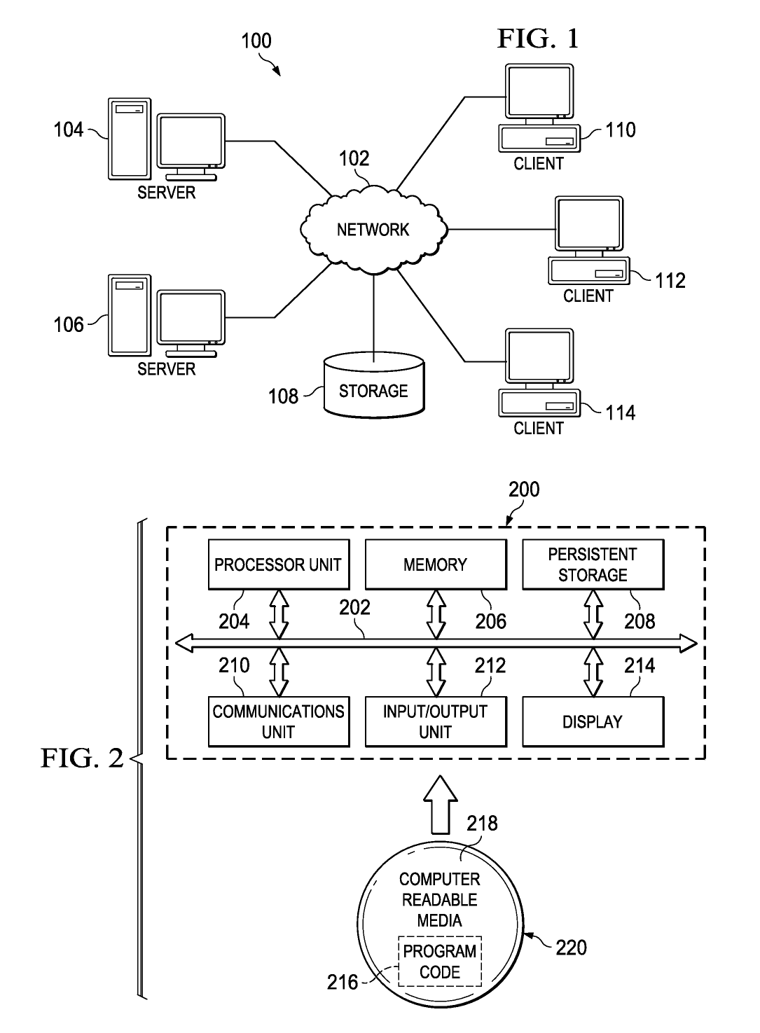

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

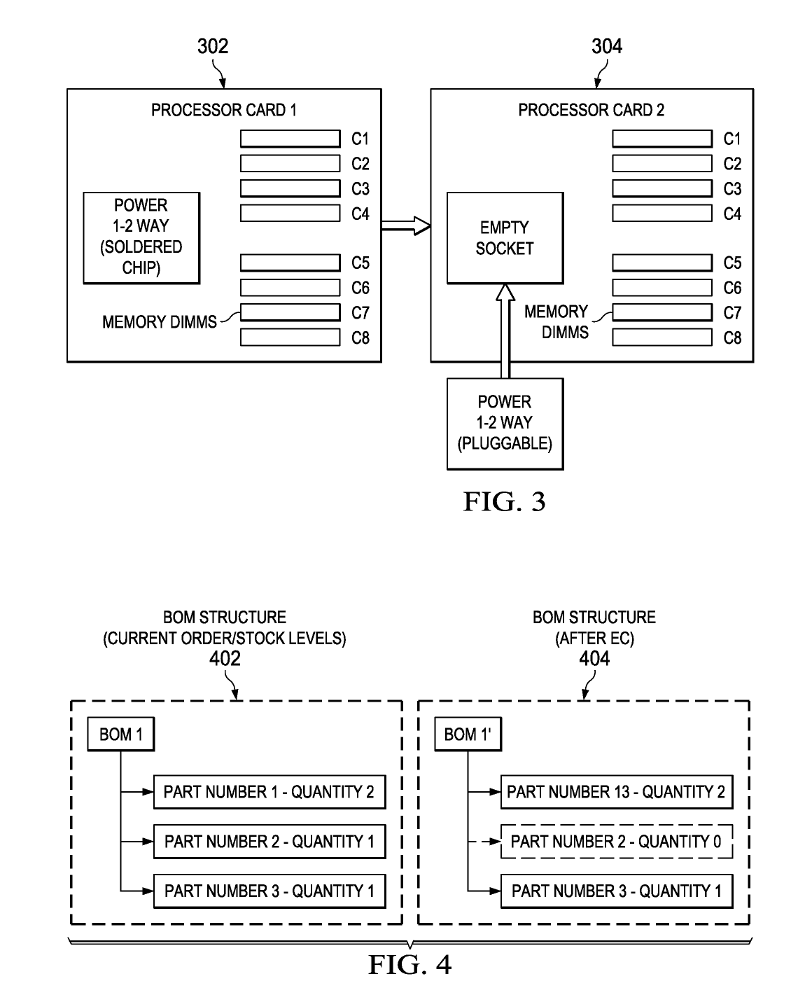

Part substitution is an industry standard practice which supports interchanging two equivalent product parts through a controlled engineering change break-in. In existing systems, part substitution allows a part in a product being manufactured to be substituted with another equivalent part, therein supporting one-for-one part replacement. However, this one-for-one part substitution is insufficient when a change in the bill of materials for the product order does not comprise a one-to-one replacement of parts. For instance, a cost reduction engineering change may specify that a set of two parts in a product being manufactured be substituted with a set of three, equivalent parts (or vice versa). An example of such an engineering change is shown in FIG. 3 which illustrates a block diagram of an exemplary engineering change break where the number of replacement parts specified in the engineering change is not equal to the number of parts specified in the order's bill of material. As shown, old processor card 302 having part number 43F4444 is manufactured according to the bill of materials with a soldered processor chip and four memory dims having part number 55F2299. The engineering change specifies that processor chip is removed from all versions of the planar, thereby making the processor chip pluggable. This engineering change requires the addition of a pluggable processor chip to the new assembly and changes the dependent memory dims. After the cutover date of the engineering change, new processor card 304 having part number 43F4499 is manufactured according to the bill of materials with a pluggable processor having part number 88G9902 and four different memory dims having part number 55F6666.

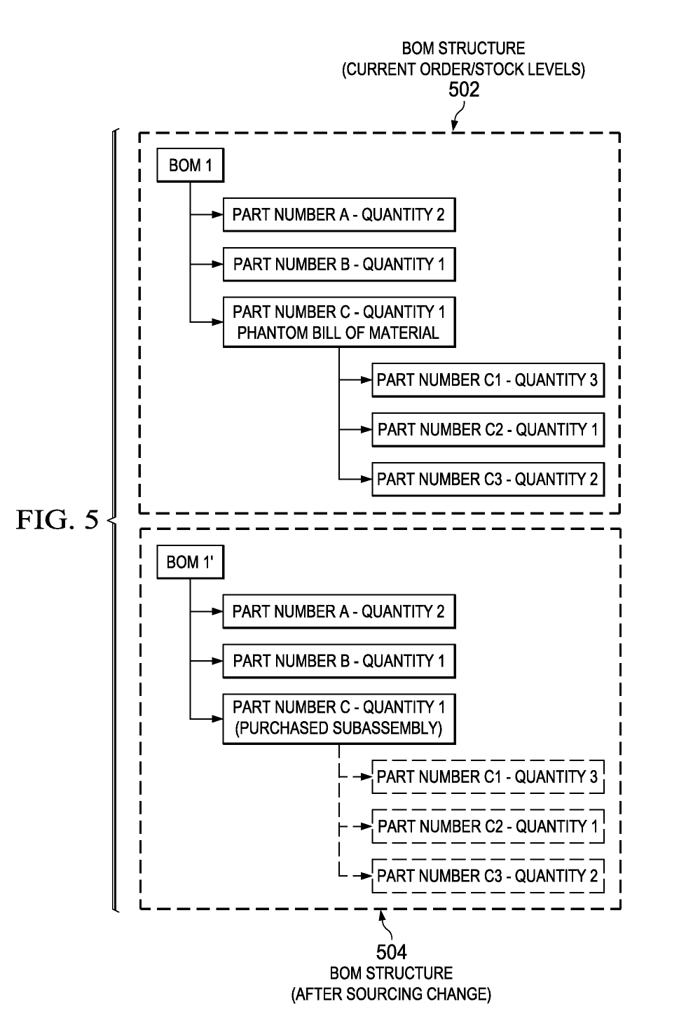

FIG. 4 also shows how one-for-one part substitution is insufficient when a change in the bill of materials for the product order does not comprise a one-to-one replacement of parts by illustrating changes to an exemplary bill of materials structure after a simple engineering change break. The original bill of materials 402 comprises three part numbers 1, 2, and 3. After the engineering change, the modified bill of materials 404 specifies two part numbers 13 and 3, where single part number 13 is used as an equivalent replacement for the set of part numbers 1 and 2. One-for-one part substitution is also insufficient where a change in how the bill of materials is fulfilled. For example, a decision to pre-assemble a subset of the bill of material, or vice versa (a common action during a source change) creates situations where one part replaces many parts, or vice versa. An example of such a part source change is shown in FIG. 5 which illustrates changes to an exemplary bill of materials structure after a simple subassembly sourcing change. The original bill of materials 502 includes part number C which is a phantom or administrative part only, i.e. it is not actually used in fulfillment of the bill of material. Part number C is essentially ignored such that sub parts C1, C2, and C3 appear on the order. After the sourcing change, the modified bill of materials 504 includes a now important and single externally purchased part number C that is equivalent to sub parts C1, C2, and C3.

Another problem with engineering change break-ins for a product is that once the cutover date has passed, all future orders for the product will use the latest or modified bill of materials content (use of the old bill of materials is not allowed). Consider an engineering change break-in example in which 1200 orders are dropped to a manufacturing facility at Time 1. A certain number of the orders are broken down into parts based on a first bill of materials (BOM1), and production begins on the orders. At Time 2, the manufacturing system creates a second bill of materials (BOM1′) based on a future engineering break-in for BOM1. The manufacturing system also sets a cutover date based on estimated future order load and inventory stock in order to use up as much of the inventory stock for parts to be changed to prevent excess inventory. At Time 3 (after the cutover date) when new orders are being processed using BOM1′, the manufacturing system still has orders with BOM1 in progress from Time 1, but only enough inventory stock to fulfill a portion of the orders with the parts specified in BOM1. Consequently, at Time 4, the manufacturing system places the orders with BOM1 that are not covered by the inventory stock on hold (production stops) and then alters these orders based on the part content specified in BOM1′. These on-hold orders may then be broken down into part numbers with BOM1′. While production of these orders may subsequently resume with BOM1′, this stop in the production process negatively impacts cycle-time (total time to produce a customer order) and customer shipments, and can potentially result in lost revenue. Even if use of the old bill of materials is technically permitted, its use is practically not permitted since there is no current method to control interchangeability within the demands of the manufacturing process. This situation is true particularly when a one-to-one match does not exist between parts on the current and previous versions of the bill of material. This situation is also true when there is a one-to-one match and a technical requirement exists that the entire group of parts must all match the current version or all match the previous version of the bill of material. In order to use a previous bill of materials version on an order, after EC cutover, the order must be modified, and while effective for a single order, this is not at all effective en masse.

Furthermore, the engineering change cutover date can create excess stock (on-hand) inventory issues, exacerbated by order alteration, cancellation, and rework activity. While some manual modification activity may enable portions of the excess stock to be used up, these approaches are very inefficient and incapable of handling stock and orders of any significant quantity. The excess stock is ultimately either reworked or scrapped. For example, at a later Time 5, a number of machines with BOM1 are returned to the factory. Since the current engineering change master specifies that BOM1 is no longer effective, the manufacturing system must scrap all of the BOM1 parts in the machines, pay significant cost for rework of these parts, or halt production and use manual processes to update the order with the BOM1 parts (manually alter the order, replacing the BOM1′ parts with BOM1 parts). Again, with existing manufacturing processes, there is currently no way to support the interchangeability of sets of parts as needed at the point of execution.

The illustrative embodiments provide a solution to the problems of determining how to substitute a new set or group of parts in an order comprising an old part order structure, how to use up excess inventory stock for old orders when all orders currently have the new part order structure, and how to allow part substitutions to be made within only a specified subset (enclosure) of the order. The illustrative embodiments provide a group substitution mechanism that allows, during product manufacturing, part substitutions to be made among sets of parts. The sets of parts may be equal or unequal in size with at least one of the sets comprising more than one part. The group substitution mechanism automates the engineering change cutover process to prevent stoppages in the manufacturing process while enabling sets of parts to be interchanged as needed to meet production demands, and significantly reduces cost to rework or scrap old inventory. A group of parts of one size that provides an equivalent function to a second group of parts of a different size may replace the second group of parts in the product at the point of execution (e.g., a substitution group comprising 3 parts may be interchangeably substituted with a substitution group of 5 parts). Combinations of specific and variable quantity part records in an order may also be modeled within a single substitution group of parts. For instance, a substitution group comprising part numbers A, B, and C, may include a specific number of part A to be substituted (quantity=“5”), a specific number of part B to be substituted (quantity=“2”), and a variable number of part C to be substituted (quantity=“All”).

The group substitution mechanism also comprises an extensible design which may be adapted to most any clear-to-build (CTB) engine or shop floor system. The group substitution mechanism employs a control table which defines the allowable substitution sets. When there is either a shortage of in-stock inventory or an excess of in-stock inventory for a product currently being manufactured, the group substitution mechanism may use the control table to determine whether a group of parts in a product may be replaced during the manufacturing process with another group of parts.

The group substitution mechanism of the illustrative embodiments further allows for focusing part substitution control to a subset of an order. For instance, the substitution of a group of parts in an order may be performed only on the parts located within a particular enclosure or area of the product. The group substitution mechanism also allows substitution models that are not tied directly to a particular bill of materials to be applied across multiple bill of materials.

The group substitution mechanism of the illustrative embodiments provides several advantages over the existing manufacturing systems. The group substitution mechanism provides a point-of-execution process control that enables the fast and efficient use of available in-stock inventory and reuse of cancelled or returned inventory, as well as reduces the need and cost of rework or scrap “obsolete” inventory. With the illustrative embodiments, the order management activity for engineering change break-in may be eliminated, since there is no longer a need to try to synchronize order content with actual on-hand inventory. The group substitution mechanism also eliminates the need for an engineering change analyzer to carefully plan and project the engineering change cutover process, which is an inherently inaccurate process. The group substitution mechanism also supports sourcing product returns at the same facility in which normal production is performed to maximize resources and inventory.

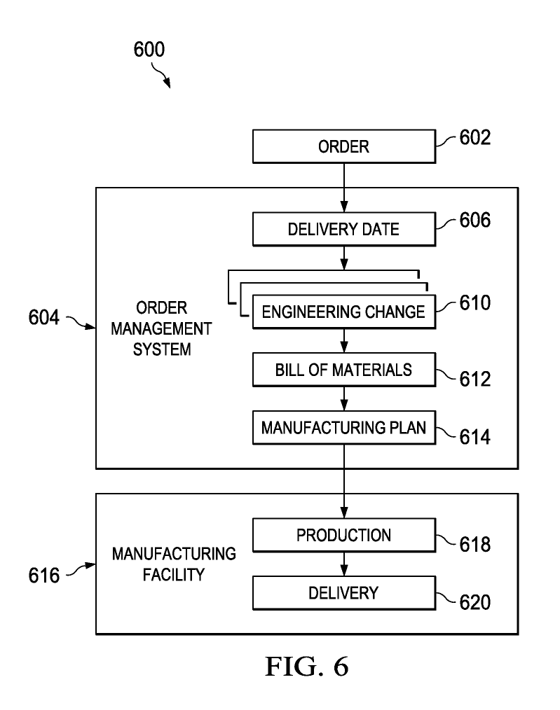

FIG. 6 is a block diagram illustrating an exemplary manufacturing system 600 in which the illustrative embodiments may be implemented. An order 602 is generated from an order source, such as from a customer or a web-based ordering system. Orders received from order sources are entered into order management system 604, which can be implemented in a server, such as server 104 in FIG. 1. Order management system 604 is responsible for managing the processes for order entry, order change, order translation, order history management, and converting customer orders to manufacturing orders. Order management system 604 sends orders to the manufacturing facility to be built for the current configuration, schedule, and customer.

Order 602 contains delivery date 606. Order management system 604 identifies and uses delivery date 606 for production planning. Based on delivery date for the order, order management system 604 determines engineering change effective dates 610 for the components required for producing the ordered product.

Once engineering change effective dates for components are identified, order management system 604 generates bill of materials 612 for the components. Order management system 604 uses bill of materials 612 to generate manufacturing plan 614, taking into account manufacturing requirements such as availability of inventory, tooling, and personnel. Manufacturing facility 616 executes production 618 based on manufacturing plan 614, resulting in delivery of the ordered product 620.

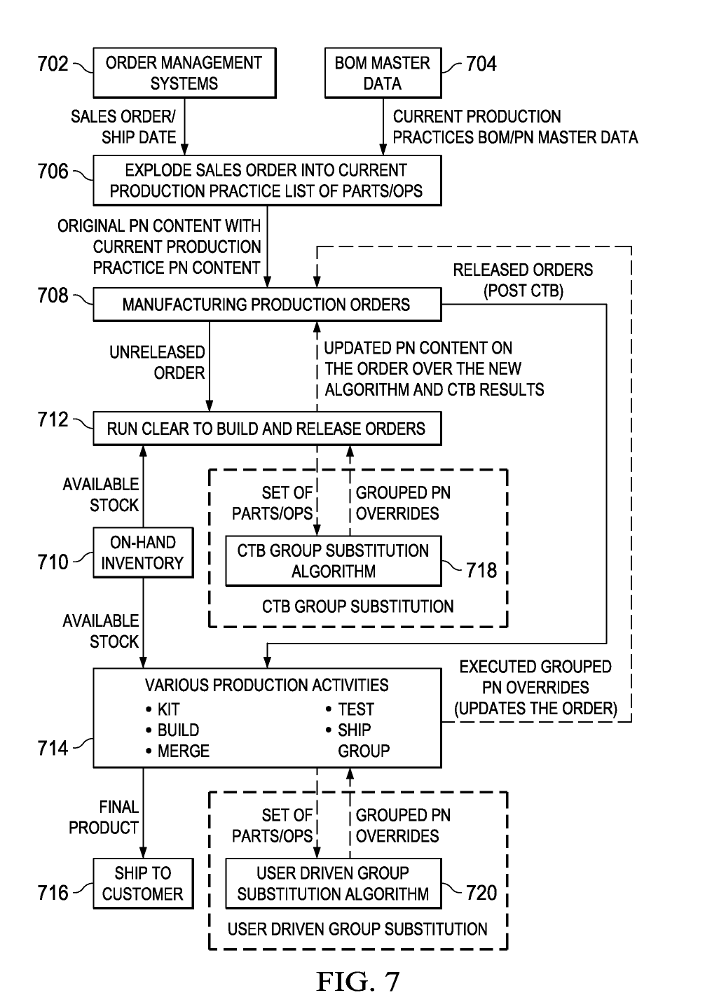

FIG. 7 is a flowchart of a high level process for substituting a group of parts from an old part order structure with a group of parts from a new part order structure in accordance with the illustrative embodiments. The process described in FIG. 7 illustrates how the group substitution mechanism of the illustrative embodiments may be integrated in the existing industry processes. The group substitution model may be implemented in conjunction with standard part number/engineering change substitution and may alter a customer order as needed during product manufacturing. The group substitution model comprises algorithms that may be integrated with and executed in an industry standard clear-to-build (CTB) process or in real-time during the manufacturing (part installation) process. The process described in FIG. 7 may be implemented within manufacturing plan process 614 in FIG. 6.

The process begins with a sales order being received by an order management system, such as order management system 604 in FIG. 6 (block 702). Bill of material/part number master data is applied to the content of the sales order (block 704), and, in accordance with existing production practices, the sales order is broken down into a list of parts numbers and a bill of materials is created for the order (block 706). The part numbers specified in the bill of materials for the order is then stored as a manufacturing production order (block 708).

A released order is one that has been made available for processing to the manufacturing team; this is always subsequent to any required validation that all necessary materials are available for processing. An unreleased order is one that has not been made available to the manufacturing team for any reason, one of which can include lack of needed inventory. For an unreleased order, information about the available in-stock inventory is provided (block 710) to the clear-to-build process, which is run on the unreleased order (block 712). The clear-to-build process determines the quantity of the finished product that can be manufactured based on actual in-stock inventory and is used to determine whether an order will be made available to the manufacturing team for actual processing. In other words, a clear-to-build compares the part numbers specified in the order against the available in-stock inventory in order to determine if the on-hand inventory is sufficient to fulfill the order before allowing/releasing the order for actual work. The clear-to-build process should be enabled with the capability to check the group substitutions. Otherwise, an order may not be released when the order could have been built.

If there is sufficient inventory available to fulfill the order, the clear-to-build process releases the order and stores the order as a released order (block 708). The manufacturing production order system may then perform production activities required to generate the final product (block 714). These production activities may include kitting, building, merging, and testing of the ordered product. The product may then be shipped to the customer (block 716).

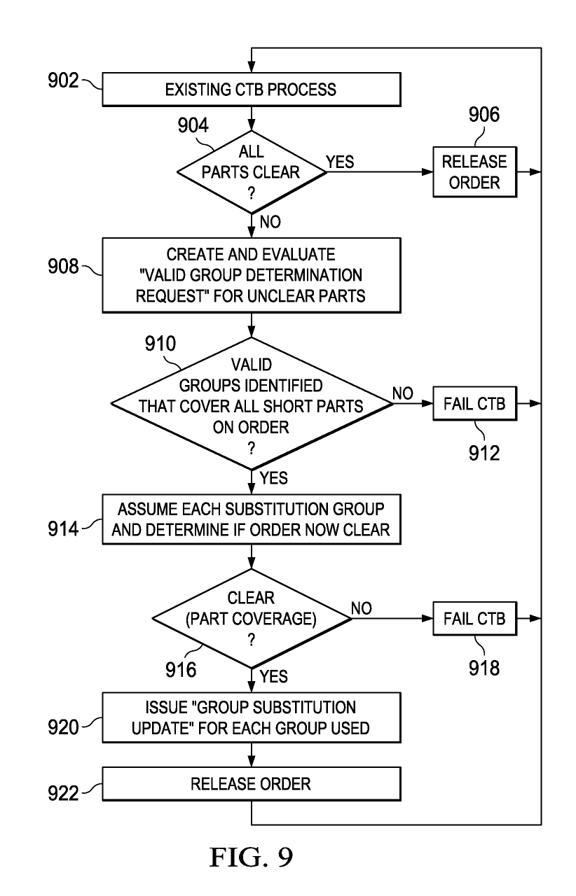

Turning back to block 712, in contrast with existing production practice, when the clear-to-build process runs in accordance with the illustrative embodiments, a clear-to-build group substitution algorithm is executed (block 718), which is described in further detail in FIG. 9. If any of the necessary parts are deemed not available in the clear-to-build analysis, this group substitution algorithm identifies the sets of parts in the current bill of materials that are equivalent in function to and which may be substituted with other sets of parts in inventory. If an equivalent group of part numbers is identified, this group of part numbers is validated to have available inventory, and if so will override the part numbers in the current bill of material, in which case the clear-to-build analysis is successful for this group of parts. An iterative clear-to-build analysis (block 712) and group substitution analysis (block 718) occur to cover all possible substitutable groups on the order.

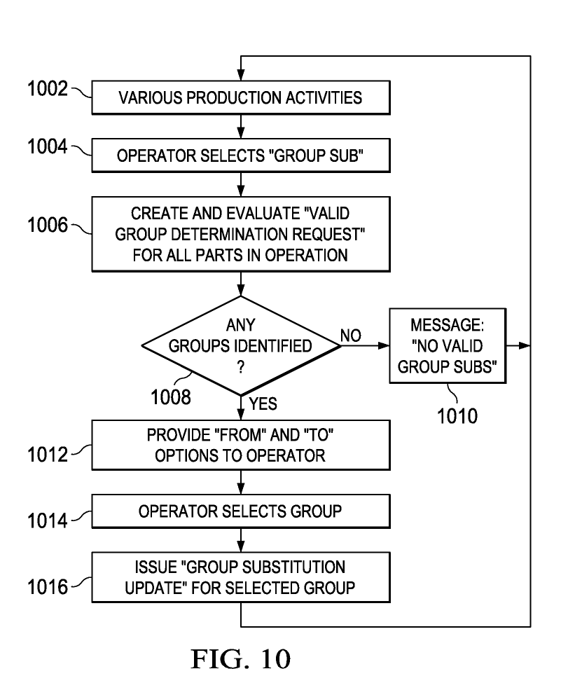

For a released order, production activities required to generate the final product are performed for the order (block 714). However, it may be some time after an order is released that the production activities are performed. In this situation, an engineering change may have caused the part numbers specified in the original bill of materials to become obsolete, and there may no longer be enough inventory on-hand to cover the order. Consequently, in contrast with existing production practice, when the production activities are performed on an order in accordance with the illustrative embodiments, a user-driven group substitution algorithm is executed (block 720), which is described in further detail in FIG. 10. User-driven substitution may be performed in real-time when manufacturing operators are actually assembling orders. This group substitution algorithm enables a manufacturing operator to modify an order in situations where the operator does not have a part on-hand as required by the order or when the operator desires to use up excess inventory in stock which is not referenced in the current order. For example, in the time between when the clear-to-build released an order and the time the order is actually built, the inventory that was identified as coverage for the order may have been unexpectedly used for a variety of reasons. Similarly, the manufacturing operator may have built the order according to requested components, but components that fail during testing are not currently available in inventory. This group substitution algorithm identifies the sets of parts in the current bill of materials that are equivalent in function to and may be substituted with other sets of parts in inventory. If an equivalent group of part numbers is identified, the production operator is allowed to select the group of parts for replacement, and the group of part numbers may then be used to override the part numbers in the current bill of materials during the installation process. Once all of the production activities have been completed (block 714), the final product is delivered to the customer (block 716).

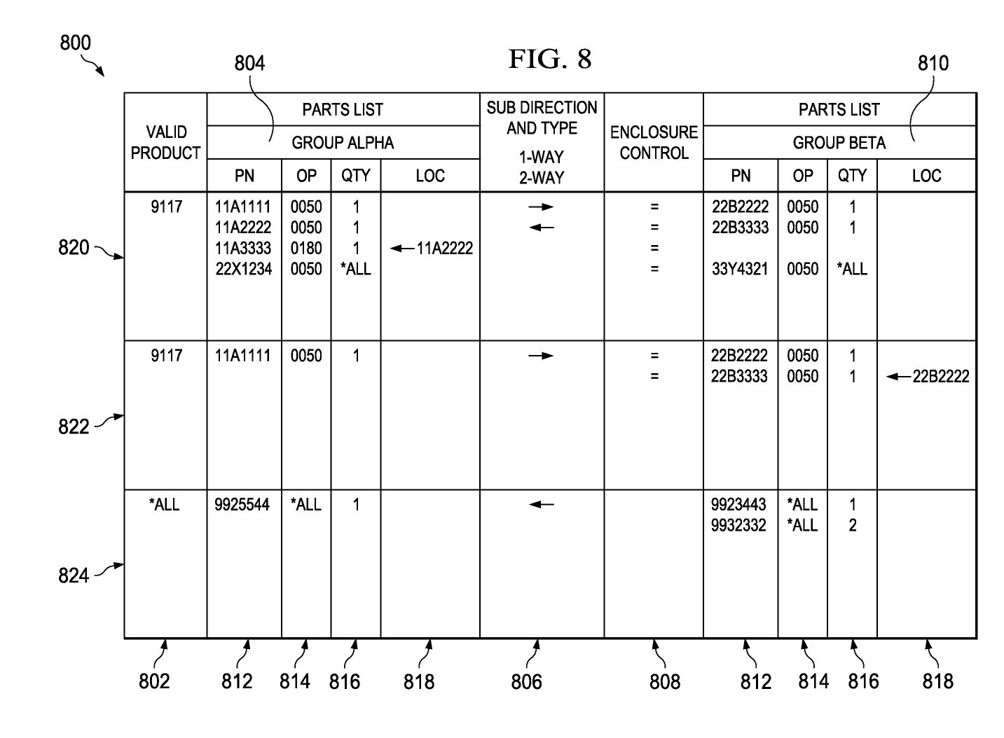

FIG. 8 is an exemplary mapping control table for defining allowable substitution sets of parts in accordance with the illustrative embodiments. The clear-to-build group substitution algorithm and the user-driven group substitution algorithm as described in FIG. 7 use the mapping control tables to substitute sets of parts as needed. The group substitution algorithms may access the control tables when there is either a shortage of in-stock inventory or an excess of in-stock inventory to determine whether a group of parts in a product may be replaced during the order processing or product manufacturing process with another group of parts.

Mapping control table 800 is a bi-directional table defining all combinations of allowable 1 way and 2 way part number substitution mappings within a single data set. Mapping control table 800 comprises various entries, including valid product 802, Alpha group parts list 804, substitution direction and type 806, enclosure control 808, and beta group parts list 810.

Valid product 802 indicates the product number of the products on which part group substitutions may be made by the group substitution algorithms. Valid product 802 allows a user to model the products for which these substitutions are available. In this illustrative example, entries within valid product 802 column include two entries for product number 9117 and one entry comprising “*ALL”. The “*ALL” entry indicates that the group substitution specified in the parts list fields are applicable to all products.

Alpha group parts list 804 and beta group parts list 810 allows the user to specify the part number group substitution mappings as a FROM and a TO listing of part numbers. When a group of parts is listed as the FROM parts group, this group of parts matches the contents of the current bill of material. When a group of parts is listed as the TO parts group, this group of parts is the target override parts list that is used to replace the parts listed in the FROM parts group. The order of the parts in alpha group parts list 804 and beta group parts list 810 is critical, as the alignment of parts between alpha group parts list 804 and beta group parts list 810 implies the part number to part number mapping.

Alpha group parts list 804 and beta group parts list 810 each comprise various sub columns, including part number (PN) 812, operation (Op) 814, quantity (Qty) 816, and location (Loc) 818. Part number 812 specifies the discrete part numbers for each part in a substitution group. Operation 814 specifies the number of the operation where the parts are to be matched to the order or assigned. Quantity 816 specifies the number of parts that is either matched to the order or assigned. Quantity 816 may be set to “*ALL” to pick up multiple occurrences of a part. When quantity 816 is set to “*ALL”, all parts are replaced 1 for 1 with the associated part from the other part group list. A quantity of “*ALL” for a part in one parts list cannot be intermixed with a specific quantity for the corresponding replacement part in the other parts list. Location 818 column allows for the inheritance of placement data, or configuration information, by specifying location assignments for the replacement parts. When the location for a replacement part is not specified, it is assumed that a part that aligns between sets will automatically inherit the same placement as the part it is replacing.

Substitution direction and type 806 column indicates which of alpha group parts list 804 and beta group parts list 810 is the FROM list of parts matching the content of the current order and which is the TO list of parts for replacing the parts in the FROM list. A field in substitution direction and type 806 column may comprise one of three items. A right pointing arrow (→) in the field indicates that the substitution direction and type is a one way substitution FROM alpha group parts list 804 to beta group parts list 810. A left pointing arrow (←) in the field indicates that the substitution direction and type is a one way substitution FROM beta group parts list 810 to alpha group parts list 804. A right and left pointing arrow in the field indicates that the substitution direction and type is a two way substitution from either alpha group parts list 804 to beta group parts list 810 or from beta group parts list 810 to alpha group parts list 804.

Enclosure control 808 provides the ability to ensure that only part sets within an enclosure or a relative placement group are substituted. Use of enclosure control 808 ensures that parts from other enclosures are not accidentally identified and substituted.

In mapping control table 800, record 820 comprises a two-way group substitution from alpha group parts list 804 to beta parts group 810 or from beta group parts list 810 to alpha group parts list 804 with an enclosure control that only allows parts that are within the same enclosure to be submitted for substitution. Record 822 comprises a one-way group substitution from alpha group parts list 804 to beta group parts list 810 only with an enclosure control that only allows parts that are within the same enclosure to be submitted for substitution. Record 824 comprises a one-way group substitution from beta group parts list 810 to alpha group parts list 804 that allows part substitutions across enclosures.

As illustrated in record 820, if the bill of materials for the order matches the part numbers in alpha group parts list 804 and these parts are also located within an enclosure as required by enclosure control 808, the part number group mappings specify that part number 22B2222 may replace part number 11A1111, part number 22B3333 may replace part number 11A2222, part number 11A3333 is removed from the bill of material, and every part number 22×1234 in the enclosure is replaced one for one with part number 33Y4321. Since substitution direction and type 806 in record 820 allows for bi-directional group substitution, the part number group mappings may be applied in the other direction, or from beta group parts list 810 to alpha group parts list 804. Thus, if the bill of materials for the order matches the part numbers in beta group parts list 810 and these parts are also located within an enclosure as required by enclosure control 808, the part number group mappings specify that part number 11A1111 may replace part number 22B2222, part number 11A2222 may replace part number 22B3333, part number 11A3333 is added to the bill of materials and inherits the installation placement of 11A2222, and every part number 33Y4321 in the enclosure may be replaced one for one with part number 22×1234.

As illustrated in record 822, if the bill of materials for the order matches the part numbers in alpha group parts list 804 and these parts are also located within an enclosure as required by enclosure control 808, the part number group mappings specify that part number 22B2222 may replace part number 11A1111, and part number 22B3333 is added to the bill of materials and inherits the installation placement of part number 22B2222. Since record 822 comprises a one way group substitution, the part number group mappings also specify that part number 11A1111 may replace part number 22B2222, part number 11A2222 may replace part number 22B3333, part number 11A3333 is added to the bill of materials and inherits the installation placement of 11A2222, and every part number 33Y4321 in the enclosure may be replaced one for one with part number 22×1234.

As illustrated in record 824, if the bill of materials for the order matches the part numbers in beta group parts list 810, the part number group mappings specify that part number 9925544 may replace part number 9923443, and part number 9932332 is removed from the bill of materials in sets of quantity 2 for every matching set with part number 992443.

Additional controls may also be included in mapping control table 800 to further limit when part substitutions may be made by the group substitution algorithms. Examples of these additional controls are shown in Table 1.

TABLE 1

| Product | Area | Number | Quantity | Date Range | On/Off |
|---|---|---|---|---|---|
| 9117 | FKIT | | 100 | 01/15/08-03/31/08 | ON |
| 9113 | | 0050 | *ALL | | ON |
| *ALL | *ALL | *ALL | | *YE (last 30 days) | OFF |

An area control may be included in mapping control table 800 that specifies the particular area in the manufacturing facility in which the part substitution for a product is allowed to be applied by the group substitution algorithms. A value of “*ALL” in this area control field indicates that the part substitution may be made in all areas of the facility. A date range control may also be included in mapping control table 800 that specifies specific time periods during which part substitutions may be made for various production, engineering change, or business reasons. An On/Off control may be included in mapping control table 800 to specify when the part substitution functions are available. For example, the first example record shown in Table 1 specifies that part substitution processing is allowed only on the 9117 product in the FKIT area for up to 100 sets during date range Jan. 15, 2008-Mar. 31, 2008. The second example record shown in Table 1 specifies that a part substitution processing is turned on at operation 0050 for product 9113 regardless of dates or area. The third example record in Table 3 specifies that part substitution process is always shut off during the last 30 days of the year.

FIG. 9 is a flowchart of the sub process for a clear-to-build group substitution in accordance with the illustrative embodiments. The process in FIG. 9 provides a detailed description of the clear-to-build group substitution in blocks 712 and 718 in FIG. 7. Blocks 902-906 represent existing clear-to-build processes, while blocks 908-922 represent the clear-to-build group substitution algorithm in accordance with the illustrative embodiments.

The process begins with a clear-to-build process being executed on an unreleased order (block 902). The clear-to-build process makes a determination as to whether all of the parts specified in the bill of materials for the order are clear (i.e., there is sufficient parts currently on-hand in inventory to fulfill the order) (block 904). If all of the parts in the order are clear (‘yes’ output of block 904), the process releases the order (block 906) and returns to block 902 to process the next unreleased order.

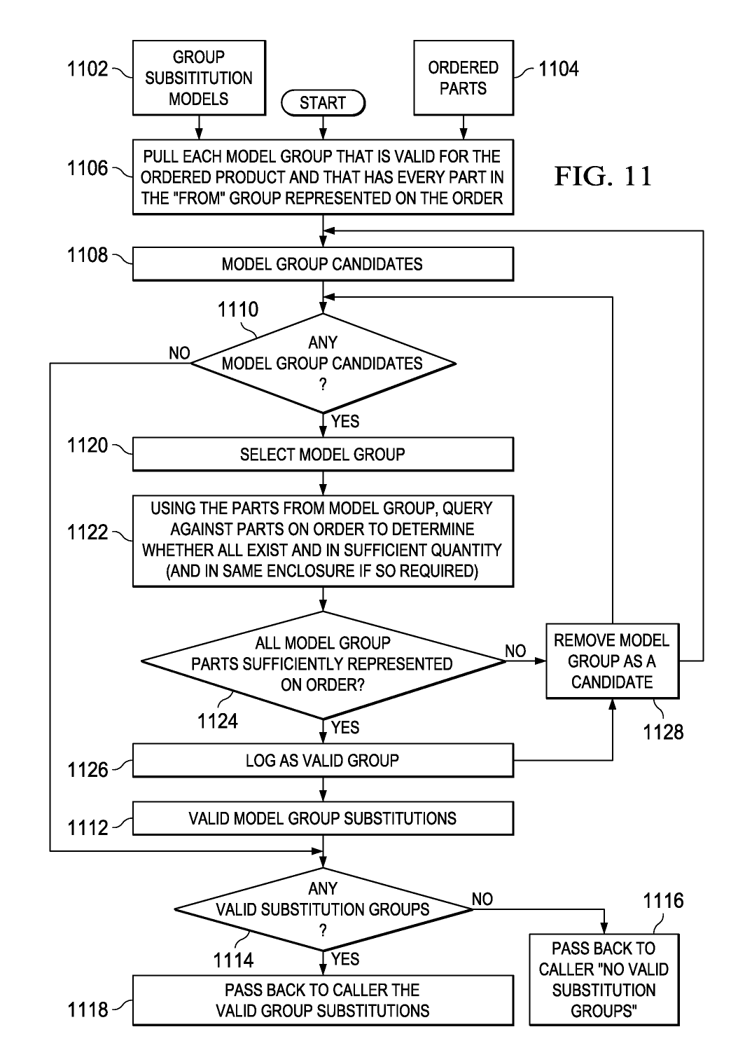

Turning back to block 904, if all of the parts in the order are not clear (‘no’ output of block 904), the clear-to-build group substitution algorithm determines if there are other sets of parts in inventory that may be substituted for the unclear parts. To perform this determination, the clear-to-build group substitution algorithm creates a valid group determination request (described in further detail in FIG. 11) for the unclear parts and evaluates the results (block 908). The valid group determination request comprises a request to identify any substitution part groups that may be used to replace the unclear parts in the order based on the data in the mapping control table in FIG. 8. Note that the substitution part group may include parts that were clear, but would be forced to change along with the unclear parts in the same group. Also, note there can be multiple substitution groups on a single order. In evaluating the list of substitution part groups returned from the valid group determination request, the clear-to-build group substitution algorithm makes a determination as to whether any of the valid substitution part groups have enough parts currently in inventory to cover all of the unclear parts in the order (block 910). If no such valid substitution part groups exist (‘no’ output of block 910), the clear-to-build process fails (block 912) and returns to block 902 to process the next unreleased order.

Turning back to block 910, if such valid substitution part groups exist (‘yes’ output of block 910), the clear-to-build group substitution algorithm assumes each identified valid substitution group (block 914). Before the order content is updated and released, the clear-to-build ensures that there are actually parts for the substitution group in inventory by “assuming” each substitution was made and validating on-hand inventory. The clear-to-build group substitution algorithm then re-runs the clear-to-build process to determine if all of the parts specified in the bill of materials (now including the substitution groups) for the order are clear (block 916).

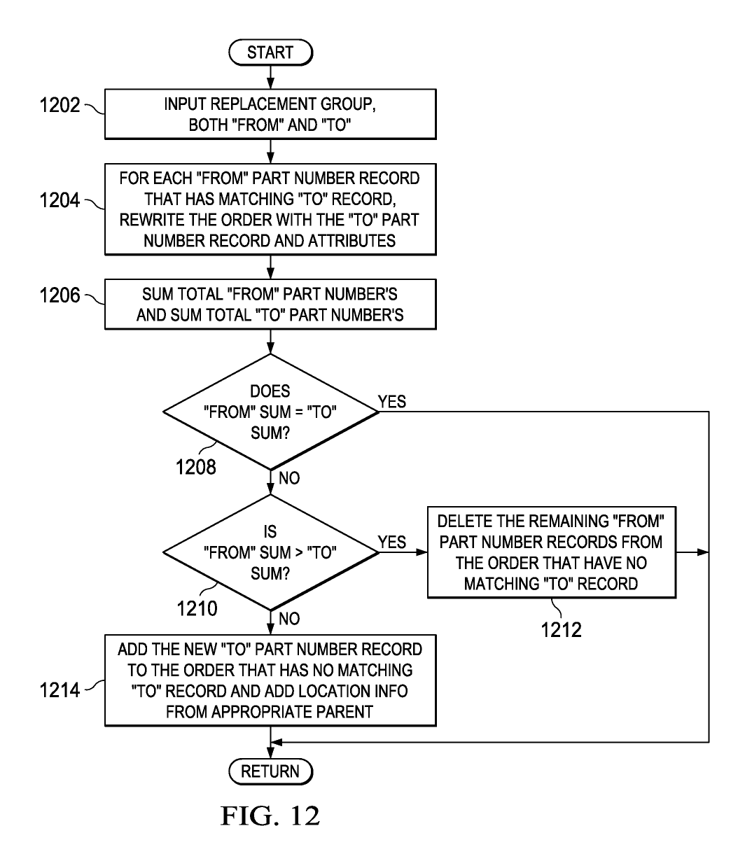

If the order comprising the substitution groups is still not clear (‘no’ output of block 916), the clear-to-build process fails (block 918) and returns to block 902 to process the next unreleased order. However, if the order comprising the substitution groups is now clear (‘yes’ output of block 916), the clear-to-build group substitution algorithm issues a group substitution update for each group used to the mapping control table in FIG. 8 (block 920). Only after all of the on-hand inventory is validated is the order content updated. The group substitution updates the bill of materials for the order by rewriting the substitution groups part numbers on the bill of material. The group substitution update is described in further detail in FIG. 12. Once the update is made, the clear-to-build group substitution algorithm releases this order (block 922) and returns to block 902 to process the next unreleased order.

FIG. 10 is a flowchart of a sub process for a user-driven group substitution in accordance with the illustrative embodiments. The process in FIG. 10 provides a detailed description of the user-driven group substitution in blocks 714 and 720 in FIG. 7. Block 1002 represents existing user-driven production processes, while blocks 1004-1016 represent the user-driven group substitution algorithm in accordance with the illustrative embodiments.

The process begins with various production activities being executed on a released order (block 1002). As the production activities occur, an operator may decide to perform a user-driven group substitution for a group of parts. In one embodiment, this decision may be made based on the fact that since production activities for an order may lag behind the time when the order is released, an engineering change may have made the part numbers specified in the original bill of materials obsolete, and there may not be sufficient inventory available to the operator to fulfill the order. In a second embodiment, this decision may be made when there is excess inventory in stock. The operator may want to use up the excess inventory in stock by replacing sets of parts specified in the order with the excess (but functionally equivalent) sets of parts in inventory. In either situation, the operator selects an option to check for available group substitutions for the order being manufactured (block 1004).

In response to receiving an operator selection of the available group substitution option, the user-driven group substitution algorithm creates a valid group determination request for all parts in the order based on the data in the mapping control table in FIG. 8 and evaluates the results (block 1006). The valid group determination request (described in further detail in FIG. 11) comprises a request to identify any substitution part groups that may be used to replace the parts in the order. In evaluating the list of substitution part groups returned from the valid group determination request, the user-driven group substitution algorithm then makes a determination as to whether any valid substitution groups have been identified (block 1008). If there are no identified valid substitution groups (‘no’ output of block 1008), the user-driven algorithm sends a “no valid group substitutions” to the operator (block 1010) and returns to block 1002 to continue processing of the order.

Turning back to block 1008, if there are identified valid substitution groups (‘yes’ output of block 1008), the user-driven group substitution algorithm provides the group substitution options to the operator (block 1012). Upon the operator selecting an identified parts group to substitute with a parts group in the order (block 1014), the user-driven group substitution algorithm issues a group substitution update for the selected group to the mapping control table in FIG. 8 (block 1016). The group substitution update is described in further detail in FIG. 12. Once the update is made, the user-driven group substitution algorithm releases the order and returns to block 1002 allowing continued processing of the order.

FIG. 11 is a flowchart of a process for determining a valid group request in accordance with the illustrative embodiments. The process in FIG. 11 provides a detailed description of the valid group determination request in block 908 in FIG. 9 and block 1006 in FIG. 10. The process begins by obtaining information regarding the group substitution models (block 1102) and the parts on order (block 1104). Each parts group in the current bill of materials that is valid for the ordered product and that has every part in the “FROM” group (the group is listed in the mapping control table in FIG. 8 as a “FROM” group) represented on the order is pulled (block 1106) and stored as model group substitution candidates (block 1108). The process obtains information regarding the model group substitution candidates and makes a determination as to whether any model group substitution candidates exist (block 1110). A model group substitution candidate is a group of parts that is defined in the mapping control table as being a “FROM” group for a current group of parts on order. If model substitution group candidates have been found (‘yes’ output of block 1110), the process selects a particular model group substitution candidate from the list of candidates (block 1120). The process then determines whether the parts in the model group are represented on the order in sufficient quantities to cover the requirements specified in the model group, and also within the same enclosure if so specified (block 1122). If the part quantities are sufficiently represented on the order and within the same enclosure (‘yes’ output of block 1124), the model group is logged as a valid substitution group (block 1126) and removed as a model group candidate (block 1128). However, if insufficient quantities of parts are on order or within the same enclosure (‘no’ output of block 1124), the model group is removed as a model group candidate (block 1128). In either case, control returns to block 1108 to determine if there are any additional model group candidates to process in block 1110. If there are additional model group candidates to process (‘yes’ output of block 1110), the iterative process in FIG. 11 continues.

However, if there are no additional model group candidates to process (‘no’ output of block 1110), the process makes a determination as to whether any valid group substitutions exist (block 1114) by obtaining information regarding the valid model group substitutions (block 1112). If no valid group substitutions exist (‘no’ output of block 1114), a “no valid group substitutions” message is passed back to the caller (block 1116). If valid group substitutions do exist (‘yes’ output of block 1114), the process returns the list of valid group substitutions to the caller (block 1118).

FIG. 12 is a flowchart of a process for updating an order based on a group substitution in accordance with the illustrative embodiments. The process in FIG. 12 provides a detailed description of the group substitution update in block 820 in FIG. 8 and block 916 in FIG. 9. At this point, the process knows that the group substitution to be made is a valid substitution group. The process begins with using the mapping control table in FIG. 8 to obtain the FROM and TO group substitution information for the order (block 1202). For each FROM part number record that has a matching TO record, the process update the order with the substitution group information by rewriting the order with the TO part number record and attributes (block 1204). The process then calculates the sum of the number of FROM part numbers and the sum of the number of TO part numbers (block 1206). A determination is made as to whether the sum total of the number of FROM part numbers equals the sum total of the number of TO part numbers (block 1208). If the sum totals are equal, the process returns. However, if the sum totals are not equal, a determination is made as to whether the sum total of the number of FROM part numbers is greater than the sum total of the number of TO part numbers (block 1210).

If the sum total of the number of FROM part numbers is greater than the sum total of the number of TO part numbers (‘yes’ output of block 1210), the process deletes the remaining FROM part number records from the order that do not have a matching TO record (block 1212), and the process returns thereafter. However, if the sum total of the number of FROM part numbers is not greater than the sum total of the number of TO part numbers (‘no’ output of block 1210), the process adds the new TO part number record to the order that has no matching TO record and adds location information from the appropriate parent (block 1214), and the process returns thereafter.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for substituting a group of parts in an order, the computer implemented method comprising:
responsive to receiving a request for an order, creating a parts list for the order;
determining whether each part in the parts list is present in current inventory stock;
responsive to a determination that any of a first group of parts in the parts list is not present in current inventory stock, determining a second group of parts in the current inventory stock is a valid substitution group for replacing the first group of parts, wherein the number of parts in the first group of parts is not equal to the number of parts in the second group of parts; and
updating the order by replacing the first group of parts in the parts list with the identified second group of parts.

2. The computer implemented method of claim 1, wherein the second group of parts in the current inventory stock is a valid substitution group for replacing the first group of parts only if the first group of parts is located within a particular subset of the order.

3. The computer implemented method of claim 1, wherein the parts list specifies a variable number of at least one part in each of the first group of parts and the second group of parts for replacement.

4. The computer implemented method of claim 1, wherein the parts list specifies a combination of specific and variable numbers of parts in each of the first group of parts and the second group of parts for replacement.

5. The computer implemented method of claim 1, wherein updating the order by replacing the first group of parts in the parts list with the identified second group of parts further comprises assigning a part in the second group of parts to a particular location in the updated order.

6. The computer implemented method of claim 1, wherein the determination that any of a first group of parts in the parts list is not present in current inventory stock is performed within a clear-to-build process.

7. The computer implemented method of claim 6, wherein determining a second group of parts in the current inventory stock is a valid substitution group for replacing the first group of parts in the clear-to-build process further comprises:
accessing a mapping control table to find substitution groups for the first group of parts;
responsive to identifying, from the mapping control table, the second group of parts equivalent in function to the first group of parts, executing the clear-to-build process using second group of parts; and
responsive to a determination that the clear-to-build process is successful, determining that the second group of parts is a valid substitution group for the first group of parts.

8. The computer implemented method of claim 7, wherein the mapping control table comprising the substitution groups is maintained independently from the parts list for the order.

9. The computer implemented method of claim 1, wherein the determination that any of a first group of parts in the parts list is not present in current inventory stock is performed within a real-time manufacturing process.

10. The computer implemented method of claim 9, wherein determining a second group of parts in the current inventory stock available for substitution for the first group of parts in the real-time manufacturing process further comprises:
receiving a group substitution request from a manufacturing operator;
responsive to receiving the group substitution request, accessing a mapping control table to find substitution groups for the first group of parts; and
responsive to identifying, from the mapping control table, the second group of parts equivalent in function to the first group of parts, notifying the manufacturing operator of the availability of the second group of parts for substitution for the first group of parts, wherein the order is updated in response to receiving a selection of the second group of parts from the manufacturing operator.

11. A computer implemented method for substituting a group of parts in an order, the computer implemented method comprising:
responsive to receiving an order in a manufacturing process, checking current inventory stock to determine if any of a first group of parts comprising excess inventory in the current inventory stock is a valid substitution group for replacing a second group of parts specified in the parts list for the order, wherein the number of parts in the first group of parts is not equal to the number of parts in the second group of parts;
responsive to a determination that the first group of parts comprising excess inventory in the current inventory stock is a valid substitution group for replacing a second group of parts specified in the parts list for the order, updating the order by replacing the second group of parts in the parts list with the first group of parts in excess inventory; and
executing the manufacturing process based on the updated order.

12. A computer program product for substituting a group of parts in an order, the computer program product comprising:
a computer usable medium having computer usable program code tangibly embodied thereon, the computer usable program code comprising:
computer usable program code for creating, in response to receiving a request for an order, a parts list for the order;
computer usable program code for determining whether each part in the parts list is present in current inventory stock;
computer usable program code for determining, in response to a determination that any of a first group of parts in the parts list is not present in current inventory stock, that a second group of parts in the current inventory stock is a valid substitution group for replacing the first group of parts, wherein the number of parts in the first group of parts is not equal to the number of parts in the second group of parts; and
computer usable program code for updating the order by replacing the first group of parts in the parts list with the identified second group of parts.

13. The computer program product of claim 12, wherein the second group of parts in the current inventory stock is a valid substitution group for replacing the first group of parts only if the first group of parts is located within a particular subset of the order.

14. The computer program product of claim 12, wherein the parts list specifies a variable number of at least one part in each of the first group of parts and the second group of parts for replacement.

15. The computer program product of claim 12, wherein the parts list specifies a combination of specific and variable numbers of parts in each of the first group of parts and the second group of parts for replacement.

16. The computer program product of claim 12, wherein the computer usable program code for updating the order by replacing the first group of parts in the parts list with the identified second group of parts further comprises computer usable program code for assigning a part in the second group of parts to a particular location in the updated order.

17. The computer program product of claim 12, wherein the computer usable program code for determining that any of a first group of parts in the parts list is not present in current inventory stock is performed within a clear-to-build process.

18. The computer program product of claim 17, wherein the computer usable program code for determining a second group of parts in the current inventory stock is a valid substitution group for replacing the first group of parts in the clear-to-build process further comprises:
computer usable program code for accessing a mapping control table to find substitution groups for the first group of parts;
computer usable program code for executing, in response to identifying, from the mapping control table, the second group of parts equivalent in function to the first group of parts, the clear-to-build process using second group of parts; and
computer usable program code for determining that the second group of parts is a valid substitution group for the first group of parts in response to a determination that the clear-to-build process is successful.

19. The computer program product of claim 12, wherein the computer usable program code for determining that any of a first group of parts in the parts list is not present in current inventory stock is performed within a real-time manufacturing process.

20. The computer program product of claim 19, wherein the computer usable program code for determining a second group of parts in the current inventory stock available for substitution for the first group of parts in the real-time manufacturing process further comprises:
computer usable program code for receiving a group substitution request from a manufacturing operator;
computer usable program code for accessing a mapping control table to find substitution groups for the first group of parts in response to receiving the group substitution request; and
computer usable program code for notifying the manufacturing operator, in response to identifying, from the mapping control table, the second group of parts equivalent in function to the first group of parts, of the availability of the second group of parts for substitution for the first group of parts, wherein the order is updated in response to receiving a selection of the second group of parts from the manufacturing operator.
